(19) United States
(12) Patent Application Publication
(10) Pub. No.: US 2026/0234897 A1
(43) Pub. Date: Aug. 13, 2026

(54) Deep Foundation Excavator

(71) Applicant: Hitachi Construction Machinery Co., Ltd., Taito-ku, Tokyo (JP)

(72) Inventors: Akira INAMOTO, Kashiwa-shi, Chiba (JP); Seiji SEKI, Omitama-shi, Ibaraki (JP); Kasumi ISOGAI, Omitama-shi, Ibaraki (JP)

(21) Appl. No.: 18/705,645

(22) PCT Filed: Jan. 26, 2023
(86) PCT No.: PCT/JP2023/002422

§ 371 Date: May 1, 2026

(30) Foreign Application Priority Data
Jan. 27, 2022 (JP) 2022-010638

(51) Int. Cl. E02F 3/47; E02D 17/13; E02F 5/20

(52) U.S. Cl. CPC E02F 3/475; E02D 17/13; E02F 5/20

(57) ABSTRACT

An arm (10) has a first opposing surface (a left side surface plate (11A) of an arm body (11) and a left side plate (14A) of a sheave mounting member (14)) and a second opposing surface (a right side surface plate (11B) of the arm body (11) and a right side plate (14B) of the sheave mounting member (14)) that are opposite in a direction (the right-and-left direction) perpendicular to a length direction of the arm (10) (the front-rear direction). A first lifting sheave (19) is disposed on an outer side surface of the left side plate (14A) of the sheave mounting member (14), and a second lifting sheave (23) is disposed on an outer side surface of the left side surface plate (11A) of the arm body (11). A first opening/closing sheave (21) is disposed on an outer side surface of the right side plate (14B) of the sheave mounting member (14), and a second opening/closing sheave (30) and an opening/closing cylinder (31) are disposed on an outer side surface of the right side surface plate (11B) of the arm body (11).

### TECHNICAL FIELD

The present disclosure relates to a deep foundation excavator suitable for use in excavation of a pit.

### BACKGROUND ART

In Japan's urban areas, recent growing demands for reconstruction of high-rise buildings create increased needs for deep foundation excavators to achieve shortened reconstruction periods and stable underground construction work on the soft ground. Since such high-rise buildings are often reconstructed indoors, deep foundation excavators are operated for excavation work under bucket lifting and other working height restrictions.

One such known type of deep foundation excavator excavating a pit on the ground and discharging excavated earth and sand is based on a hydraulic excavator and provided with a telescopic clamshell-type working mechanism including a multistage telescopic arm and a clamshell bucket. However, it is itself hard to introduce deep foundation excavators provided with a telescopic clamshell-type working mechanism at working sites under working height restrictions.

Meanwhile, a deep foundation excavator where a clamshell bucket is attached to a tip end of a cylindrical arm mounted on a boom tip end of a hydraulic excavator via a wire rope has been proposed (see Patent Document 1). This type of deep foundation excavator includes a bucket lifting device and a bucket opening/closing device provided within a cylindrical arm to excavate a pit on the ground by raising and lowering the clamshell bucket with the bucket lifting device, and opening and closing the clamshell bucket with the bucket opening/closing device.

### PRIOR ART DOCUMENT

### Patent Document

Patent Document 1: Japanese Patent Laid-Open No. 2003-147800 A

### SUMMARY OF THE INVENTION

A deep foundation excavator according to Patent Document 1 prevents interference with obstacles present in surrounding areas of a bucket lifting and opening/closing device and the deep foundation excavator and improve the external appearance of the deep foundation excavator by accommodating within a cylindrical arm the bucket lifting and opening/closing device allowing a bucket to lift, and open and close.

Nevertheless, in the deep foundation excavator according to Patent Document 1, such parts as a hydraulic cylinder that constitutes the bucket lifting and opening/closing device, a wire rope and a plurality of sheave are accommodated within the arm. Thus, the operational efficiency for regularly replacing a wire rope and maintaining a hydraulic cylinder or a sheave can unfortunately be lowered. In particular, when more sheaves are employed to increase the excavation depth, sheaves can be maintained in a more complex manner, resulting in further lowered operational efficiency.

In addition, the deep foundation excavator according to Patent Document 1 needs a larger arm in order to allow the bucket lifting and opening/closing device to be accommodated within such an arm, and the resulting operational efficiency for transporting the deep foundation excavator to a working site (transportability) will be lowered. An additional problem is a lowered operational efficiency for essential assembly of the bucket lifting and opening/closing device within the arm.

An object of the present invention is to provide a deep foundation excavator capable of enhancing the operational efficiency for maintaining a bucket lifting and opening/closing device.

A deep foundation excavator according to the present invention includes a self-propelled vehicle body and a working mechanism provided on the vehicle body, characterized in that the working mechanism includes: a boom provided on the vehicle body; an arm provided on a tip end of the boom; a bucket lifting and opening/closing device provided on the arm; and a clamshell bucket liftably provided on the arm and excavating a pit by a lifting operation and an opening/closing operation with the bucket lifting and opening/closing device, characterized in that the bucket lifting and opening/closing device includes: a lifting cylinder provided on the arm; a first lifting sheave and a first opening/closing sheave moving in a length direction of the arm with the lifting cylinder; a second lifting sheave separated from the first lifting sheave and provided on the arm; a second opening/closing sheave separated from the first opening/closing sheave and provided on the arm; an opening/closing cylinder moving the second opening/closing sheave relative to the first opening/closing sheave; a lifting rope whose one end is mounted on the arm and whose other end is mounted on the clamshell bucket, and whose intermediate portion is looped around the first lifting sheave and the second lifting sheave; and an opening/closing rope whose one end is mounted on the arm and whose other end is mounted on the clamshell bucket, and whose intermediate portion is looped around the first opening/closing sheave and the second opening/closing sheave, characterized in that the arm has a first opposing surface and a second opposing surface that are opposite in a direction perpendicular to the length direction of the arm, the first lifting sheave and the second lifting sheave are disposed on an outer side surface of the first opposing surface, and the first opening/closing sheave, the second opening/closing sheave and the opening/closing cylinder are disposed on an outer side surface of the second opposing surface.

According to the present invention, the first lifting sheave, the second lifting sheave, the first opening/closing sheave, the second opening/closing sheave and the opening/closing cylinder are each disposed on an outer side surface of the arm. Thus, a working space for maintaining the parts of the bucket lifting and opening/closing device can largely be secured and the operational efficiency for maintenance can be enhanced.

### BRIEF DESCRIPTION OF THE DRAWINGS

FIG. 1 is a left side view of a deep foundation excavator according to one embodiment of the present invention.

FIG. 2 is a left side view of a bucket lifting and opening/closing device.

FIG. 3 is a plan view of the bucket lifting and opening/closing device.

FIG. 4 is a right side view of the bucket lifting and opening/closing device.

FIG. 5 is an exploded view of an arm.

FIG. 6 is a cross-sectional view of a connection between an arm body and a guide arm taken from arrow VI-VI of FIG. 2.

FIG. 7 is a cross-sectional view of the guide arm, a sheave mounting member, and the like taken from arrow VII-VII of FIG. 2.

FIG. 8 is a cross-sectional view of a connection between the arm body and a lifting cylinder taken from arrow VIII-VIII of FIG. 2.

FIG. 9 is a cross-sectional view of the guide arm, the sheave mounting member, a first lifting sheave, a first opening/closing sheave, and the like taken from arrow IX-IX of FIG. 3.

FIG. 10 is a cross-sectional view of the arm body, an opening/closing sheave moving mechanism, and the like taken from arrow X-X of FIG. 3.

FIG. 11 is a cross-sectional view of the arm body, a second lifting sheave, a second opening/closing sheave, and the like taken from arrow XI-XI of FIG. 3.

FIG. 12 is a cross-sectional view of the arm body, a slack adjusting sheave, a slack adjusting sheave moving mechanism, a lifting guide sheave, an opening/closing guide sheave, and the like taken from arrow XII-XII of FIG. 3.

### MODE FOR CARRYING OUT THE INVENTION

A deep foundation excavator according to one embodiment of the present invention will be described in detail with reference to the attached drawings. In this embodiment, a length direction of an arm is defined as front-and-rear direction, and a direction perpendicular to the length direction of the arm is defined as right-and-left direction.

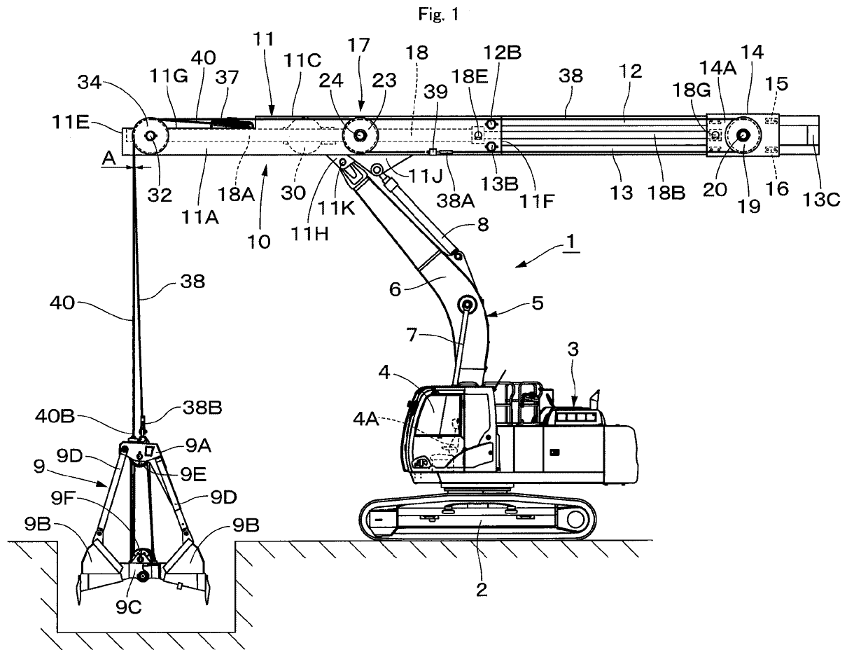

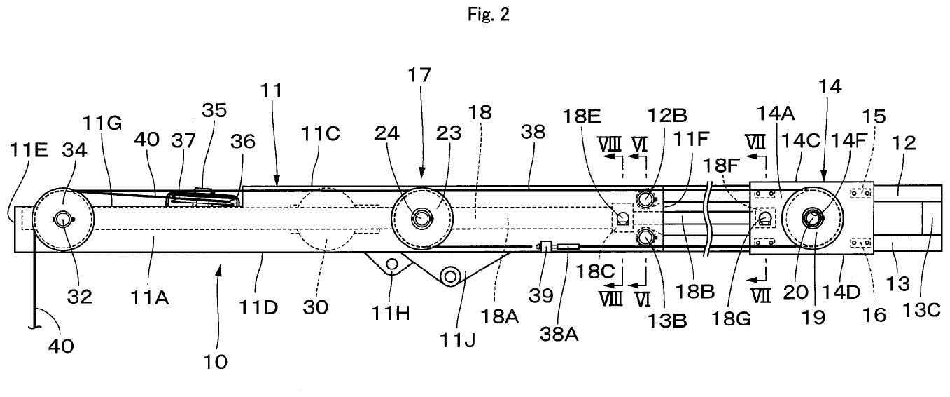

In FIG. 1, a deep foundation excavator 1 is manufactured based upon a crawler-type hydraulic excavator, for example. The deep foundation excavator 1 is configured by a crawler-type self-propelled lower traveling structure 2, an upper revolving Structure 3 mounted rotatably on the lower traveling structure 2, and a later-described working mechanism 5 provided on the upper revolving structure 3. The lower traveling structure 2 and the upper revolving structure 3 constitute a vehicle body of the deep foundation excavator 1.

A cab 4 is provided on a left front side of the upper revolving structure 3. The cab 4 defines an operator's room for an on-board operator to steer the deep foundation excavator 1. An operator's seat 4A for the operator to be seated is provided in the cab 4, and an operating device (not shown) for performing a traveling operation of the lower traveling structure 2 and a revolving operation of the upper revolving structure 3 and operating the working mechanism 5 is provided on the periphery of the operator's seat 4A.

The working mechanism 5 is configured to include a boom 6 provided rotatably on the upper revolving structure 3 in the vertical direction, a later-described arm 10, a clamshell bucket 9, and a bucket lifting and opening/closing device 17. A boom cylinder 7 is provided between the upper revolving structure 3 and the boom 6, and the boom 6 rotates with respect to the upper revolving structure 3, depending on expanding/contracting operations of the boom cylinder 7. An arm cylinder 8 is provided between the boom 6 and the arm 10, and the arm 10 rotates with respect to the boom 6, depending on expanding/contracting operations of the arm cylinder 8.

The clamshell bucket 9 is liftably suspended from a front end of the arm 10, using a later-described lifting rope 38. The clamshell bucket 9 has a bucket support portion 9A, a pair of buckets 9B, a connecting bracket 9C, and a pair of opening/closing arms 9D. The pair of buckets 9B are openably provided on a lower side of the bucket support portion 9A. The pair of buckets 9B are rotatably connected to the connecting bracket 9C. The pair of opening/closing arms 9D connect the bucket support portion 9A and the pair of buckets 9B. A plurality of upper sheaves 9E is provided at the bucket support portion 9A, and a plurality of lower sheaves 9F opposite the upper sheaves 9E in the vertical direction is provided on the connecting bracket 9C.

The other end 38B of a lifting rope 38 is mounted at the bucket support portion 9A of the clamshell bucket 9. A later-described opening/closing rope 40 is alternately looped around the upper sheaves 9E and the lower sheaves 9F of the clamshell bucket 9, and the other end 40B of an opening/closing rope 40 is mounted at the bucket support portion 9A of the clamshell bucket 9.

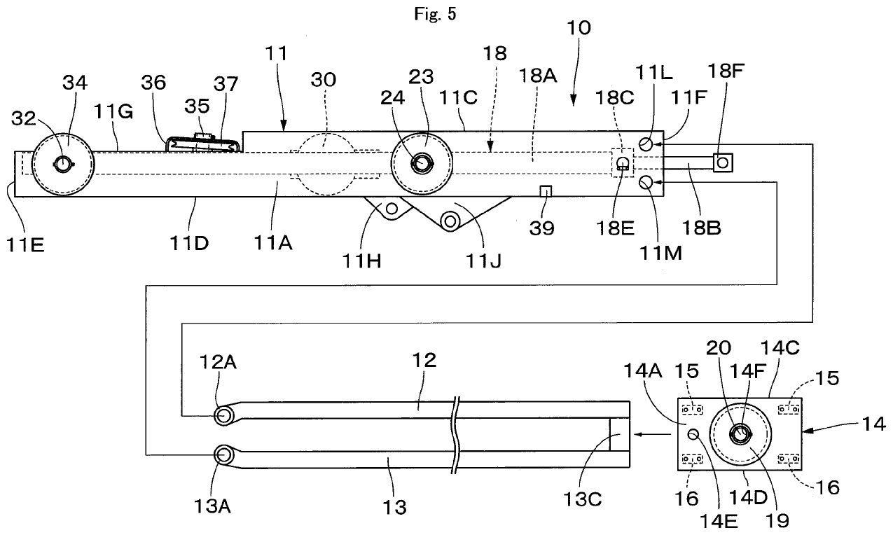

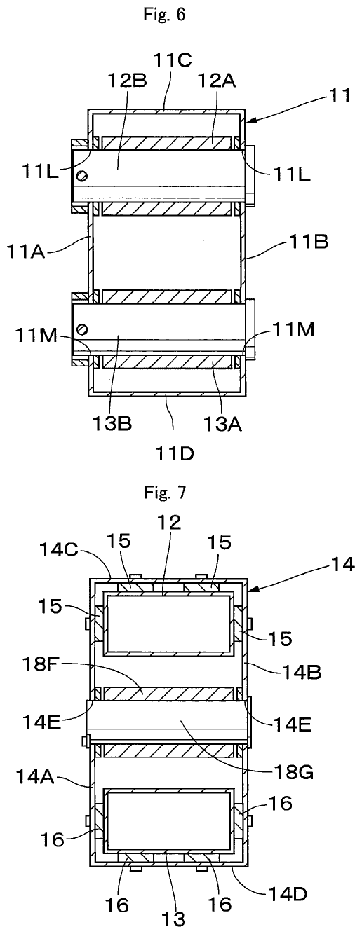

The arm 10 is mounted rotatably on a tip end of the boom 6. As shown in FIGS. 5 and 6, the arm 10 is separably configured by an arm body 11 formed of a hollow cylinder and extending in the front-rear direction, a pair of guide arms 12, 13, and a sheave mounting member 14. The pair of guide arms 12, 13 are detachably provided on a rear side of the arm body 11. The sheave mounting member 14 is moveably mounted on the guide arms 12, 13.

The arm body 11 constitutes a base of the arm 10 and is formed as an angular tubular body having a rectangular-shaped cross section. The arm body 11 is surrounded by a left side surface plate 11A as a first opposing surface opposite in a direction (the right-and-left direction) perpendicular to a length direction of the arm 10 (the front-rear direction), a right side surface plate 11B as a second opposing surface, an upper surface plate 11C, and a lower surface plate 11D. The upper surface plate 11C connects upper ends of the left side surface plate 11A and the right side surface plate 11B. The lower surface plate 11D connects lower ends of the left side surface plate 11A and the right side surface plate 11B. Herein, the left side surface plate 11A as the first opposing surface of the arm body 11 is disposed on the operator's seat 4A side provided in the cab 4 of the upper revolving structure 3 to provide good visibility for an on-board operator seated in the operator's seat 4A.

The interval between the left side surface plate 11A and the right side surface plate 11B is set to be smaller than that between the upper surface plate 11C and the lower surface plate 11D. A front end 11E of the arm body 11 is a closed end and a rear end 11F of the arm body 11 is an open end. A stepped surface 11G is formed on a front side from a central portion in the front-rear direction defined on the upper surface plate 11C of the arm body 11, the stepped surface being lower than on a rear side from the central portion (the interval with the lower surface plate 11D is shorter). A later-described intermediate guide sheave 37 is provided on the stepped surface 11G. A boom mounting bracket 11H and a cylinder mounting bracket 11J are provided on the lower surface plate 11D of the arm body 11. The boom mounting bracket 11H is rotatably connected to the tip end of the boom 6 via a connecting pin 11K (see FIG. 1). The cylinder mounting bracket 11J is pin-coupled to a tip end of the arm cylinder 8 whose base end is mounted on the boom 6. Therefore, the arm body 11 rotates around the connecting pin 11K in the front-rear direction or the vertical direction, depending on expanding/contracting operations of the arm cylinder 8.

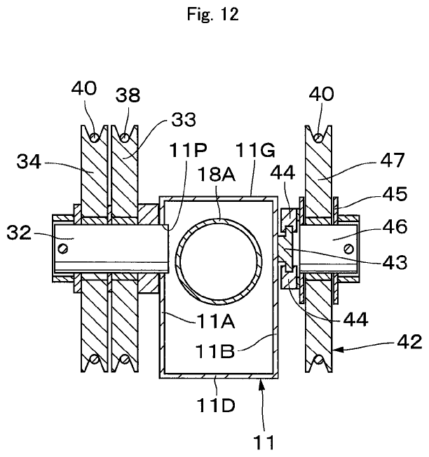

Two pin through holes 11L, 11M are formed on the rear end 11F side of the left side surface plate 11A and the right side surface plate 11B, respectively, so as to be separated vertically and penetrate in the right-and-left direction. Later-described connecting pins 12B, 13B are inserted into the pin through holes 11L, 11M. Also, trunnion pin through holes 11N penetrating in the right-and-left direction are concentrically formed on a front side from the pin through holes 11L, 11M of the left side surface plate 11A and the right side surface plate 11B (see FIG. 8). Later-described trunnion pins 18E are inserted into the two trunnion pin through holes 11N. Meanwhile, a front-side shaft mounting hole 11P penetrating in the right-and-left direction is formed on the front end 11E side of the left side surface plate 11A (see FIG. 12). A later-described guide sheave support shaft 32 is fixed to the front-side shaft mounting hole 11P. An intermediate shaft mounting hole 110 penetrating in the right-and-left direction is formed at an intermediate portion of the left side surface plate 11A in the front-rear direction (see FIG. 11). A later-described second lifting sheave shaft 24 is fixed to the intermediate shaft mounting hole 11Q.

The guide arms 12, 13 are detachably mounted on the rear side of the arm body 11 as a pair in the vertical direction. The guide arms 12, 13 are each formed as an angular tubular body having a rectangular-shaped cross section, and extend in the front-rear direction. Cylinder portions 12A, 13A extending in the right-and-left direction are fixed to front ends of the guide arms 12, 13, respectively. The connecting pin 12B is inserted on the inner peripheral side of the cylinder portion 12A of the guide arm 12, and both ends of the connecting pin 12B are inserted into the pin through holes 11L of the arm body 11. The connecting pin 13B is inserted on the inner peripheral side of the cylinder portion 13A of the guide arm 13, and both ends of the connecting pin 13B are inserted into the pin through holes 11M of the arm body 11. Meanwhile, rear ends of the guide arms 12, 13 are connected via a connecting member 13C. As a result, the guide arms 12, 13 extend rearward from the rear end 11F of the arm body 11, with a constant interval in the vertical direction.

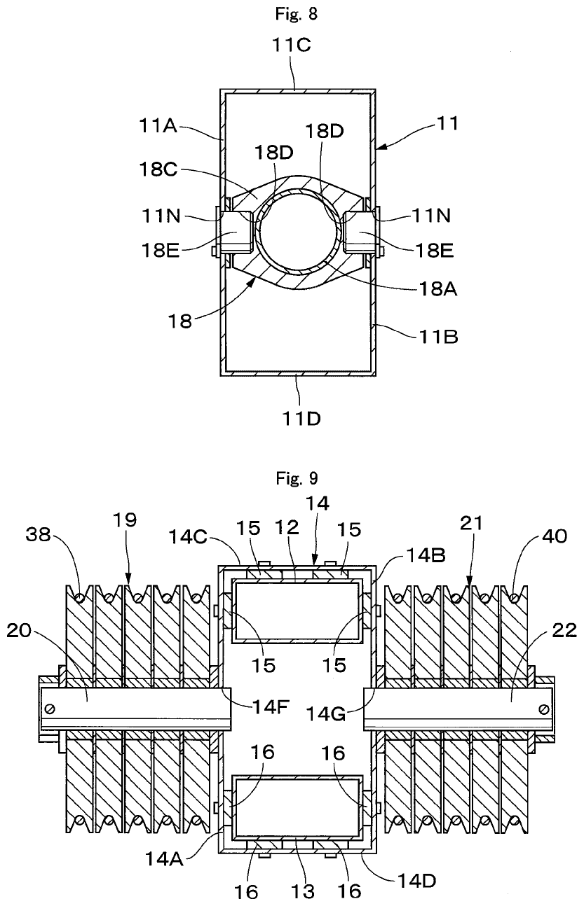

The sheave mounting member 14 is moveably mounted on the pair of guide arms 12, 13 to constitute part of the arm 10. The sheave mounting member 14 moves in the front-rear direction along the guide arms 12, 13, with a later-described first lifting sheave 19 and a first opening/closing sheave 21 mounted on the sheave mounting member 14. As shown in FIGS. 7 and 9, the sheave mounting member 14 is formed as a cylinder having a rectangular-shaped cross section equivalent to the arm body 11 to surround the guide arms 12, 13 from outside. That is, the sheave mounting member 14 is formed as a short cylinder (frame body) surrounded by a left side plate 14A as a first opposing surface, a right side plate 14B as a second opposing surface, an upper plate 14C and a lower plate 14D.

Pin through holes 14E penetrating in the right-and-left direction are concentrically formed at front side portions of the left side plate 14A and the right side plate 14B, respectively, constituting the sheave mounting member 14. Later-described rod mounting pins 18G are inserted into the two pin through holes 14E. A left shaft mounting hole 14F penetrating in the right-and-left direction is formed at a central portion of the left side plate 14A constituting the sheave mounting member 14, and a right shaft mounting hole 14G penetrating in the right-and-left direction is formed at a central portion of the right side plate 14B. A later-described first lifting sheave shaft 20 is mounted in the left shaft mounting hole 14F, and a later-described first opening/closing sheave shaft 22 is mounted in the right shaft mounting hole 14G (see FIG. 9).

Slide plates 15 are each provided between inner peripheral surfaces of the left side plate 14A, the right side plate 14B and the upper plate 14C of the sheave mounting member 14 and the guide arm 12, and each of the Slide plates 15 slidably abuts on the guide arm 12. Slide plates 16 are each provided between the inner peripheral surfaces of the left side plate 14A, the right side plate 14B, and the lower plate 14D of the sheave mounting member 14 and the guide arm 13, and each of the Slide plates 16 slidably abuts on the guide arm 13. The Slide plates 15, 16 are fixed to the sheave mounting member 14, using bolts and the like to smoothly move (slide) the sheave mounting member 14 with respect to the guide arms 12, 13.

Next, the bucket lifting and opening/closing device 17 employed in this embodiment will be described.

The bucket lifting and opening/closing device 17 is provided on the arm 10. The bucket lifting and opening/closing device 17 performs a number of operations including lifting operations and opening/closing operations of the clamshell bucket 9. The bucket lifting and opening/closing device 17 is configured to include a later-described lifting cylinder 18, a first lifting sheave 19, a first opening/closing sheave 21, a second lifting sheave 23, a second opening/closing sheave 30, an opening/closing cylinder 31, an intermediate guide sheave 37, the lifting rope 38, the opening/closing rope 40, a slack adjusting sheave 47, and a slack adjusting cylinder 48.

The lifting cylinder 18 is provided in the arm body 11 constituting the arm 10, and extends in a length direction of the arm body 11 (in the front-and-rear direction). The lifting cylinder 18 raises and lowers the clamshell bucket 9 by expanding or contracting, depending on operations of the operating device provided in the cab 4. The lifting cylinder 18 has a tube 18A, a piston (not shown) inserted into the tube 18A, and a rod 18B whose base end is mounted on the piston and whose tip end projects from the tube 18A.

As shown in FIG. 8, a mounting flange 18C is fixed to the tube 18A, and two pin holes 18D are concentrically formed through the mounting flange 18C by interposing the tube 18A. Two trunnion pins 18E inserted into the trunnion pin through holes 11N of the arm body 11 (the left side surface plate 11A and the right side surface plate 11B) are fitted to the two pin holes 18D. As a result, the tube 18A of the lifting cylinder 18 is supported swingably around the trunnion pins 18E relative to the arm body 11. Meanwhile, a cylindrical mounting eye 18F is provided on a tip end of the rod 18B of the lifting cylinder 18, and the rod mounting pin 18G is inserted into the pin through hole 14E of the sheave mounting member 14 and the mounting eye 18F (see FIG. 7).

Thus, the tube 18A of the lifting cylinder 18 is mounted on the arm body 11, and the rod 18B is mounted on the sheave mounting member 14. Therefore, the sheave mounting member 14 moves in the front-rear direction along the guide arms 12, 13 by expanding and contracting the lifting cylinder 18.

The first lifting sheave 19 is mounted on an outer side surface of the left side plate 14A (first opposing surface) constituting the sheave mounting member 14 via a first lifting sheave shaft 20. The first lifting sheave shaft 20 has a base end fixed to the left shaft mounting hole 14F of the sheave mounting member 14 (left side plate 14A) and a tip end projecting leftward from the sheave mounting member 14. A plurality of (e.g., five) first lifting sheaves 19 is provided to be arranged in the axial direction of the first lifting sheave shaft 20, and is rotatably supported around the first lifting sheave shaft 20 relative to the sheave mounting member 14.

The first opening/closing sheave 21 is mounted on an outer side surface of the right side plate 14B (second opposing surface) constituting the sheave mounting member 14 via a first opening/closing sheave shaft 22. The first opening/closing sheave shaft 22 has a base end fixed to the right shaft mounting hole 14G of the sheave mounting member 14 (right side plate 14B) and a tip end projecting rightward from the sheave mounting member 14. A plurality of (e.g., five) first opening/closing sheaves 21 is provided to be arranged in the axial direction of the first opening/closing sheave shaft 22, and is rotatably supported around the first opening/closing sheave shaft 22 relative to the sheave mounting member 14.

The second lifting sheave 23 is separated from the first lifting sheave 19 and provided on the arm body 11. The second lifting sheave 23 is mounted on an outer side surface of the left side surface plate 11A (first opposing surface) constituting the arm body 11 via a second lifting sheave shaft 24. The second lifting sheave shaft 24 has a base end fixed to the intermediate shaft mounting hole 110 of the arm body 11 (left side surface plate 11A) and a tip end projecting leftward from the arm body 11. A plurality of (e.g., four) second lifting sheaves 23 is provided to be arranged in the axial direction of the second lifting sheave shaft 24, and is rotatably supported around the second lifting sheave shaft 24 relative to the arm body 11. Therefore, the sheave mounting member 14 moves, depending on expanding/contracting operations of the lifting cylinder 18, to allow the first lifting sheave 19 mounted on the sheave mounting member 14 to approach or separate from the second lifting sheave 23. The lifting rope 38 is looped around the first lifting sheave 19 and the second lifting sheave 23.

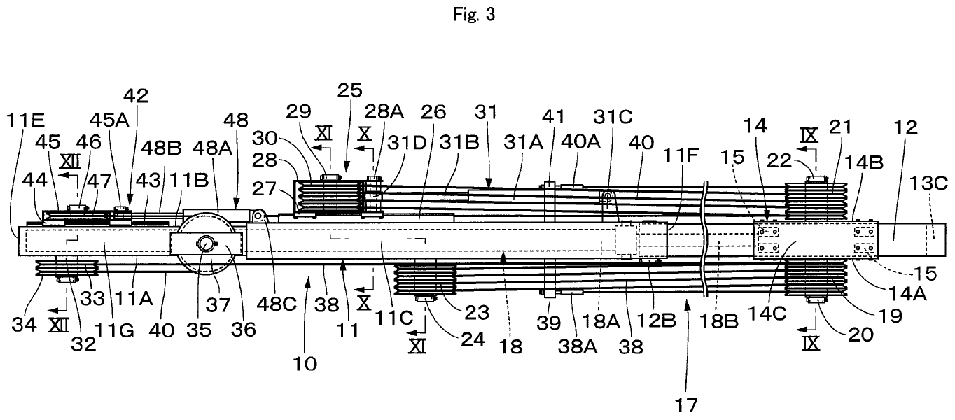

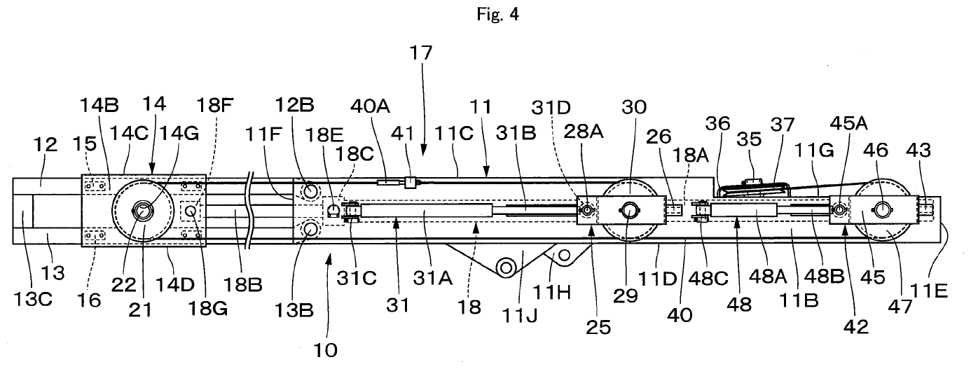

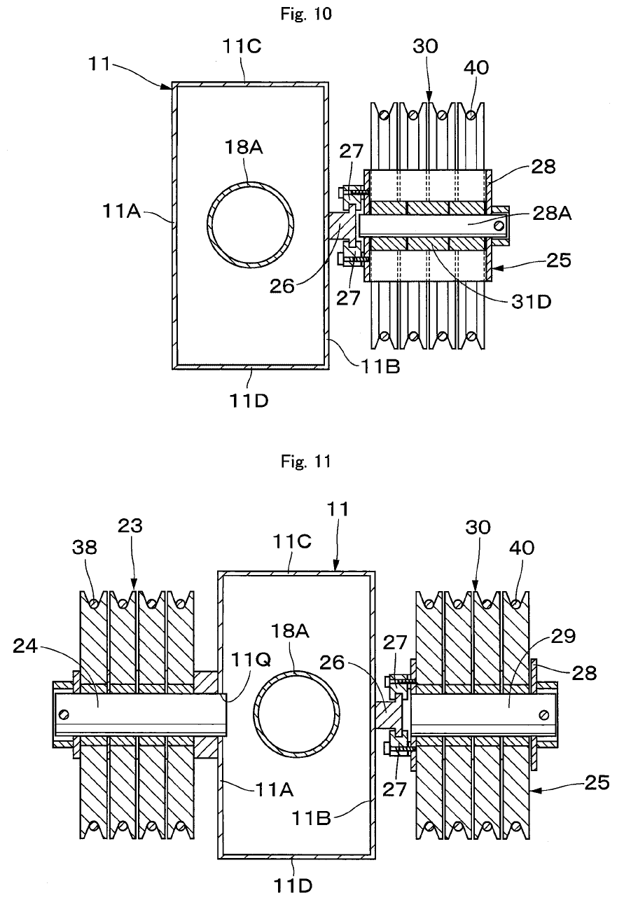

A opening/closing sheave moving mechanism 25 is located at an intermediate portion of the arm body 11 in the front-rear direction and provided on the right side surface plate 11B (second opposing surface). The opening/closing sheave moving mechanism 25 moveably supports the second opening/closing sheave 30 in the front-rear direction. As shown in FIGS. 3 and 10, the opening/closing sheave moving mechanism 25 is configured to include a guide rail 26, a pair of slide members 27, a frame member 28, and a second opening/closing sheave shaft 29.

The guide rail 26 is composed of a block having a T-shaped cross section extending in the front-rear direction and fixed to the right side surface plate 11B of the arm body 11. The pair of slide members 27 are defined in the vertical direction by interposing the guide rail 26 and each slidably engaged with the guide rail 26. The frame member 28 is mounted on the pair of slide members 27, using bolts and the like. A rod mounting pin 28A extending in the right-and-left direction is mounted on the frame member 28, and a later-described mounting eye 31D of the opening/closing cylinder 31 is mounted on the rod mounting pin 28A. In addition, the second opening/closing sheave shaft 29 extending in the right-and-left direction is mounted on the frame member 28 to be adjacent to the rod mounting pin 28A.

The second opening/closing sheave 30 is rotatably mounted on the second opening/closing sheave shaft 29 of the opening/closing sheave moving mechanism 25. That is, the second opening/closing sheave 30 is moveably provided on an outer side surface of the right side surface plate 11B (second opposing surface) constituting the arm body 11 in the front-rear direction via the opening/closing sheave moving mechanism 25. A plurality of (e.g., four) second opening/closing sheaves 30 is provided to be arranged in the axial direction of the second opening/closing sheave shaft 29 provided on the opening/closing sheave moving mechanism 25, and rotatably supported around the second opening/closing sheave shaft 29 relative to the arm body 11.

The opening/closing cylinder 31 is located on the rear side of the arm body 11 (rear end 11F side) and provided on the right side surface plate 11B. The opening/closing cylinder 31 extends in the front-rear direction to allow the second opening/closing sheave 30 to approach or separate from the first opening/closing sheave 21. The opening/closing cylinder 31 has a tube 31A, a piston (not shown) inserted into the tube 31A, and a rod 31B whose base end is mounted on the piston and whose tip end projects from the tube 31A. The bottom side of the tube 31A is mounted on the rear end 11F side of the right side surface plate 11B of the arm body 11 via a bracket 31C. The cylindrical mounting eye 31D is provided on a tip end of the rod 31B, and the mounting eye 31D is mounted on the frame member 28 of the opening/closing sheave moving mechanism 25 via the rod mounting pin 28A. Therefore, the second opening/closing sheave 30 mounted on the opening/closing sheave moving mechanism 25 moves in the front-rear direction, depending on expanding/contracting operations of the opening/closing cylinder 31, to approach or separate from the first opening/closing sheave 21.

The guide sheave support shaft 32 is provided on the left side surface plate 11A located on the front end 11E side of the arm body 11. As shown in FIG. 12, a base end of the guide sheave support shaft 32 is fixed to the front-side shaft mounting hole 11P of the left side surface plate 11A, and a tip end of the guide sheave support shaft 32 projects leftward from the left side surface plate 11A. The guide sheave support shaft 32 rotatably supports a lifting guide sheave 33 and an opening/closing guide sheave 34.

The lifting guide sheave 33 and the opening/closing guide sheave 34 are provided on the left side surface plate 11A (first opposing surface) of the arm body 11 via the guide sheave support shaft 32. The lifting guide sheave 33 and the opening/closing guide sheave 34 have an identical diameter. The lifting guide sheave 33 guides the lifting rope 38 looped around the first lifting sheave 19 and the second lifting sheave 23 to the clamshell bucket 9. The opening/closing guide sheave 34 guides the opening/closing rope 40 looped around the first opening/closing sheave 21, the second opening/closing sheave 30, and a later-described intermediate guide sheave 37 and the slack adjusting sheave 47 to the clamshell bucket 9. As a result, as shown in FIG. 1, for example, the clamshell bucket 9 can be raised and lowered in the vertical direction, using the lifting rope 38 looped around the lifting guide sheave 33 disposed on the front end of the arm 10, with the arm 10 held horizontal to the ground.

Herein, the lifting guide sheave 33 and the opening/closing guide sheave 34 are disposed on the front end 11E side of the left side surface plate 11A of the arm body 11 for an on-board operator seated in the operator's seat 4A to be given good visibility. As a result, the operator can visually confirm the state of the lifting rope 38 and the opening/closing rope 40 mounted on the clamshell bucket 9, and operate the bucket lifting and opening/closing device 17. Further, the lifting guide sheave 33 and the opening/closing guide sheave 34 have an identical diameter to allow an interval “A” between the lifting rope 38 and the opening/closing rope 40 in the front-rear direction near the front end 11E of the arm body 11 to be as small as possible (see FIG. 1). The resulting smaller interval “A” between the lifting rope 38 and the opening/closing rope 40 in the front-rear direction can restrict movement of the clamshell bucket 9 to the upper revolving structure 3 side, thereby smoothly performing lifting operations of the clamshell bucket 9.

An intermediate guide sheave shaft 35 is provided on the stepped surface 11G located on the front end 11E side of the arm body 11. A frame member 36 bent in a U-shaped cross section is fixed to the stepped surface 11G of the arm body 11. The intermediate guide sheave shaft 35 has a base end mounted on the stepped surface 11G and a tip end mounted on the frame member 36 to be slightly inclined rearward from the stepped surface 11G and extend upward.

The intermediate guide sheave 37 is rotatably provided on the stepped surface 11G of the arm body 11 via the intermediate guide sheave shaft 35. The intermediate guide sheave 37 is arranged between the opening/closing guide sheave 34 provided on the left side surface plate 11A of the arm body 11 and the slack adjusting sheave 47 provided on the right side surface plate 11B of the arm body 11. The intermediate guide sheave 37 guides the opening/closing rope 40 to the opening/closing guide sheave 34 by allowing the opening/closing rope 40 extending from the slack adjusting sheave 47 to be looped around.

Thus, the opening/closing rope 40 can smoothly be guided from the slack adjusting sheave 47 to the opening/closing guide sheave 34 via the intermediate guide sheave 37 even in a case where the slack adjusting sheave 47 and the opening/closing guide sheave 34 are disposed to be opposite each other by interposing the arm body 11. Also, the intermediate guide sheave 37 is disposed on the stepped surface 11G, having a small interval with the lower surface plate 11D, defined on the upper surface plate 11C of the arm body 11. This configuration can restrict projection of the intermediate guide sheave 37 from the upper surface plate 11C of the arm body 11, and the height of the deep foundation excavator 1 above the ground can be reduced as much as possible in a case where the deep foundation excavator 1 excavates a pit, with the arm 10 held horizontal to the ground (the state in FIG. 1).

The lifting rope 38 is provided between the arm 10 and the clamshell bucket 9 to liftably support the clamshell bucket 9. The lifting rope 38 is composed of a wire rope, and one end 38A of the lifting rope 38 is mounted on a left stay 39 projected to the left side surface plate 11A of the arm body 11. The other end 38B of the lifting rope 38 is mounted at the bucket support portion 9A of the clamshell bucket 9 (see FIG. 1). An intermediate portion of the lifting rope 38 is alternately looped around a plurality of first lifting sheaves 19 and a plurality of second lifting sheaves 23.

The opening/closing rope 40 is provided between the arm 10 and the clamshell bucket 9 to open and close the pair of buckets 9B of the clamshell bucket 9. The opening/closing rope 40 is composed of a wire rope, and one end 40A of the opening/closing rope 40 is mounted on a right stay 41 projected to the right side surface plate 11B of the arm body 11. The other end 40B of the opening/closing rope 40 is mounted at the bucket support portion 9A of the clamshell bucket 9 (see FIG. 1). An intermediate portion of the opening/closing rope 40 is alternately looped around the plurality of first opening/closing sheaves 21 and the plurality of second opening/closing sheaves 30. Also, the other end 40B side of the opening/closing rope 40 is alternately looped around the plurality of upper sheaves 9E and the plurality of lower sheaves 9F constituting the clamshell bucket 9.

The clamshell bucket 9 gets lower as the lifting cylinder 18 contracts and the first lifting sheave 19 approaches the second lifting sheave 23. In addition, the clamshell bucket 9 gets higher as the lifting cylinder 18 expands and the first lifting sheave 19 separates from the second lifting sheave 23. Therefore, the lowering distance (depth of pit) of the clamshell bucket 9 can optionally be set by increasing the numbers of the first lifting sheaves 19 and the second lifting sheaves 23 or varying the stroke of the lifting cylinder 18. Meanwhile, the clamshell bucket 9 is opened as the opening/closing cylinder 31 contracts and the second opening/closing sheave 30 approaches the first opening/closing sheave 21. Also, the clamshell bucket 9 is closed as the opening/closing cylinder 31 expands and the second opening/closing sheave 30 separates from the first opening/closing sheave 21.

A slack adjusting sheave moving mechanism 42 is located on the front end 11E side of the arm body 11 and provided on the right side surface plate 11B (second opposing surface). The slack adjusting sheave moving mechanism 42 moveably supports the slack adjusting sheave 47 in the front-rear direction. As shown in FIGS. 3 and 12, the slack adjusting sheave moving mechanism 42 is configured to include a guide rail 43, a pair of slide members 44, a frame member 45, and a slack adjusting sheave shaft 46.

The guide rail 43 is composed of a block having a T-shaped cross section extending in the front-rear direction and fixed to the right side surface plate 11B of the arm body 11. The pair of slide members 44 are defined in the vertical direction by interposing the guide rail 43 and each slidably engaged with the guide rail 43. The frame member 45 is mounted on the pair of slide members 44, using bolts and the like. A rod mounting pin 45A extending in the right-and-left direction is mounted on the frame member 45, and a later-described rod 48B of the slack adjusting cylinder 48 is mounted on the rod mounting pin 45A. In addition, the slack adjusting sheave shaft 46 extending in the right-and-left direction is mounted on the frame member 45 to be adjacent to the rod mounting pin 45A.

The slack adjusting sheave 47 is rotatably mounted on the slack adjusting sheave shaft 46 of the slack adjusting sheave moving mechanism 42. That is, the slack adjusting sheave 47 is moveably provided on the right side surface plate 11B (second opposing surface) of the arm body 11 in the front-rear direction via the slack adjusting sheave moving mechanism 42. The slack adjusting sheave 47 is configured by one sheave and rotatably supported around the slack adjusting sheave shaft 46 relative to the arm body 11.

The opening/closing rope 40 looped around the plurality of first opening/closing sheaves 21 and the plurality of second opening/closing sheaves 30 is consecutively looped around the slack adjusting sheave 47, the intermediate guide sheave 37, and the opening/closing guide sheave 34. Then, the other end 40B side of the opening/closing rope 40 looped around the opening/closing guide sheave 34 is looped around the upper sheave 9E and the lower sheave 9F of the clamshell bucket 9. The other end 40B of the opening/closing rope 40 is mounted on the bucket support portion 9A. Thus, the slack adjusting sheave 47, the plurality of second opening/closing sheaves 30, and the plurality of first opening/closing sheave 21 around which the opening/closing rope 40 is looped are consecutively disposed from the front end 11E of the arm body 11.

The slack adjusting cylinder 48 is located on a front side of the opening/closing sheave moving mechanism 25 and provided on the right side surface plate 11B of the arm body 11. The slack adjusting cylinder 48 extends in the front-rear direction to allow the slack adjusting sheave 47 to approach or separate from the second opening/closing sheave 30. The slack adjusting cylinder 48 has a tube 48A, a piston (not shown) inserted into the tube 48A, and the rod 48B whose base end is mounted on the piston and whose tip end projects from the tube 48A. The bottom side of the tube 48A is mounted on the right side surface plate 11B of the arm body 11 via a bracket 48C. A tip end of the rod 48B is mounted on the frame member 45 of the slack adjusting sheave moving mechanism 42 via a pin or the like.

Therefore, the slack adjusting sheave 47 mounted on the slack adjusting sheave moving mechanism 42 moves in the front-rear direction, depending on expanding/contracting operations of the slack adjusting cylinder 48, to approach or separate from the second opening/closing sheave 30. As a result, in a case where the clamshell bucket 9 touches the ground to loosen the opening/closing rope 40 for pit excavation using the deep foundation excavator 1, for example, the slack adjusting cylinder 48 is expanded and the slack adjusting sheave 47 is allowed to separate from the second opening/closing sheave 30 to successfully eliminate (remove) slack of the opening/closing rope 40.

The deep foundation excavator 1 according to this embodiment is configured as described above, and the operation of excavating a pit using the deep foundation excavator 1 will be explained.

An on-board operator in the cab 4 allows the deep foundation excavator 1 to travel to a working site, and thereafter as shown in FIG. 1, operates the boom cylinder 7 to lift the tip end of the boom 6 upward, and for example, operates the arm cylinder 8 to hold the arm 10 horizontal to the ground. The posture of the arm 10 relative to the ground (degree of inclination of the arm 10) can be varied according to working height restrictions. Next, after the closed clamshell bucket 9 is disposed over the ground where a pit is to be excavated, the lifting cylinder 18 is contracted. As a result, the sheave mounting member 14 moves frontward along the guide arms 12, 13 and the first lifting sheave 19 approaches the second lifting sheave 23, and the first opening/closing sheave 21 approaches the second opening/closing sheave 30. Consequently, the lifting rope 38 and the opening/closing rope 40 are fed from the arm 10 to lower the clamshell bucket 9.

When the clamshell bucket 9 reaches the height of several meters above the ground (e. g., 2 to 3 meters), the operator stops a lowering operation of the clamshell bucket 9 with the lifting cylinder 18, and then contracts the opening/closing cylinder 31. As a result, the second opening/closing sheave 30 mounted on the opening/closing sheave moving mechanism 25 approaches the first opening/closing sheave 21. Consequently, the opening/closing rope 40 is fed from the arm 10 to fully open the pair of buckets 9B of the clamshell bucket 9. After the clamshell bucket 9 is fully open, the operator contracts the lifting cylinder 18 again, thereby allowing the fully open clamshell bucket 9 to move down and a lower end of the pair of buckets 9B to touch the ground.

After the lower end of the clamshell bucket 9 touches the ground, the operator continues the contracting operation of the lifting cylinder 18 to feed the lifting rope 38 and loosen the lifting rope 38 such that upon closing the clamshell bucket 9, it can move down to go underground. Next, the operator expands the slack adjusting cylinder 48 before closing the clamshell bucket 9 to allow the slack adjusting sheave 47 mounted on the slack adjusting sheave moving mechanism 42 to separate from the second opening/closing sheave 30. Consequently, only the slack of the opening/closing rope 40 is removed, with the lifting rope 38 loosened.

Subsequently, the operator pulls up the opening/closing rope 40 to the arm 10 side by expanding the opening/closing cylinder 31 to allow the second opening/closing sheave 30 mounted on the opening/closing sheave moving mechanism 25 to separate from the first opening/closing sheave 21. As a result, the clamshell bucket 9 can close by self-weight while going underground to scoop a large amount of earth and sand. In this case, the slack adjusting cylinder 48 is expanded prior to closing the clamshell bucket 9 to remove only the slack of the opening/closing rope 40, with the lifting rope 38 loosened. Consequently, the clamshell bucket 9 can be closed upon expansion of the opening/closing cylinder 31 to swiftly excavate earth and sand.

The operator expands the lifting cylinder 18 after closing the clamshell bucket 9 to scoop earth and sand. At this time, if the lifting rope 38 is loosened after scooping the earth and sand, the lifting cylinder 18 is expanded and concurrently the slack adjusting cylinder 48 is contracted. This operation allows the first lifting sheave 19 mounted on the sheave mounting member 14 to separate from the second lifting sheave 23 and the lifting rope 38 to be pulled up to the arm 10 side, and the first opening/closing sheave 21 to separate from the second opening/closing sheave 30 and the opening/closing rope 40 to be pulled up to the arm 10 side. Consequently, the lifting rope 38 and the opening/closing rope 40 are pulled up to the arm 10 side together, and the clamshell bucket 9 is raised by the lifting rope 38 and the opening/closing rope 40, with the earth and sand held in the bucket, and moves upward.

After the clamshell bucket 9 is raised to the outside of the pit, for example, the upper revolving structure 3 is revolved to move the clamshell bucket 9 above a loading platform of a dump truck (not shown). In this state, the operator contracts the opening/closing cylinder 31 to allow the second opening/closing sheave 30 mounted on the opening/closing sheave moving mechanism 25 to approach the first opening/closing sheave 21. Consequently, the opening/closing rope 40 is pulled out of the arm 10 to open the clamshell bucket 9, thereby releasing excavated earth and sand onto the loading platform of the dump truck.

Herein, the lifting rope 38 raising and lowering the clamshell bucket 9 is mounted on the clamshell bucket 9 via the lifting guide sheave 33 disposed on the left side surface plate 11A of the arm body 11. The opening/closing rope 40 opening and closing the clamshell bucket 9 is also mounted on the clamshell bucket 9 via the opening/closing guide sheave 34 disposed on the left side surface plate 11A of the arm body 11. The lifting guide sheave 33 and the opening/closing guide sheave 34 are disposed on the front end 11E side of the left side surface plate 11A of the arm body 11 for an on-board operator seated in the operator's seat 4A to be given good visibility. As a result, the operator can confirm the state of the lifting rope 38 and the opening/closing rope 40 mounted on the clamshell bucket 9, and operate the bucket lifting and opening/closing device 17 to enhance the operability.

Thus, after releasing the earth and sand onto the loading platform of the dump truck, the upper revolving structure 3 is revolved to move the clamshell bucket 9 above the pit, and the above-described operations can be repeated to excavate a pit.

Herein, the deep foundation excavator 1 according to this embodiment has the arm 10 that is separably configured by the arm body 11, the pair of guide arms 12, 13, and the sheave mounting member 14. The first lifting sheave 19 is disposed on the outer side surface of the left side plate 14A (first opposing surface) of the sheave mounting member 14, and the second lifting sheave 23 is disposed on the outer side surface of the left side surface plate 11A (first opposing surface) of the arm body 11. In addition, the first opening/closing sheave 21 is disposed on the outer side surface of the right side plate 14B (second opposing surface) of the sheave mounting member 14, and the second opening/closing sheave 30 is disposed on the outer side surface of the right side surface plate 11B (second opposing surface) of the arm body 11.

As a result, in this embodiment, a large working space can be secured outside the arm 10 when the lifting rope 38 and the opening/closing rope 40 are regularly replaced, and the bucket lifting and opening/closing device 17 is maintained to maintain and inspect the first lifting sheave 19, the second lifting sheave 23, the first opening/closing sheave 21, the second opening/closing sheave 30 and the like. Therefore, the operational efficiency for maintenance can be enhanced, compared to a case where a bucket lifting and opening/closing device is configured to be accommodated within a cylindrical arm, for example.

In this embodiment, the secured operational efficiency for maintenance can achieve increased numbers of the first lifting sheaves 19, the second lifting sheaves 23, the first opening/closing sheaves 21, and the second opening/closing sheaves 30. This configuration can increase the excavation depth by the deep foundation excavator 1.

Moreover, the arm body 11 that is to be a base of the arm 10 is formed of an angular tubular body having a cross section small enough to accommodate the lifting cylinder 18 within the arm, the guide arms 12, 13 are formed of an angular tubular body whose cross section is smaller than the arm body 11, and the sheave mounting member 14 is formed of an angular tubular body that is shorter than the arm body 11. Therefore, the arm 10 according to this embodiment can be made to significantly be lighter than arms of conventional technologies having a bucket lifting and opening/closing device accommodated inside to enhance the operational efficiency for transporting the deep foundation excavator (transportability) to a working site. Further, in the bucket lifting and opening/closing device 17 according to this embodiment, parts Other than the lifting cylinder 18 such as the opening/closing cylinder 31 and the slack adjusting cylinder 48 are mounted outside the arm 10. Thus, for example, the operational efficiency for assembling a bucket lifting and opening/closing device can be improved as in deep foundation excavators of conventional technologies, compared to a case where the bucket lifting and opening/closing device is configured to be accommodated within the arm, and manufacturing costs can also be reduced.

In addition, the deep foundation excavator 1 has the arm 10 provided with the bucket lifting and opening/closing device 17 that is separably configured by the arm body 11, the pair of guide arms 12, 13, and the sheave mounting member 14. Thus, even in a case where a space required for carrying a deep foundation excavator 1 cannot be secured at a narrow indoor working site, for example, the arm 10 is removed from the boom 6 and the removed arm 10 is separated and the separated parts are loaded onto a relatively small transport vehicle and carried to a working site, and then the parts can be assembled into an arm 10 at the working site.

That is, for example, as shown in FIG. 5, the guide arm 12 is mounted on the arm body 11 provided with the lifting cylinder 18, the second lifting sheave 23, the second opening/closing sheave 30, the lifting guide sheave 33, the opening/closing guide sheave 34, the intermediate guide sheave 37, the slack adjusting sheave 47 and the like, using the connecting pin 12B, and the guide arm 13 is mounted thereon, using the connecting pin 13B. Next, after the sheave mounting member 14 provided with the first lifting sheave 19 and the first opening/closing sheave 21 is mounted on the guide arms 12, 13, the mounting eye 18F provided on the rod 18B of the lifting cylinder 18 is mounted on the sheave mounting member 14, using the rod mounting pin 18G. After assembling the arm 10 in this manner, the vehicle body of the deep foundation excavator 1 is carried to an indoor working site or the like, and the arm 10 can be mounted on the tip end of the boom 6 of the deep foundation excavator 1 to excavate a pit.

Further, the entire length of the arm 10 can be set according to varied lengths of the guide arms 12, 13 mounted on the arm body 11. Therefore, in a case where the entire length of the arm 10 is increased by prolonging the guide arms 12, 13, the excavation depth of a pit by the deep foundation excavator 1 can be increased, and in a case where the guide arms 12, 13 are contracted to reduce the entire length of the arm 10, the arm 10 can be made to be lighter to enhance the transportability.

Thus, in the deep foundation excavator 1 according to this embodiment, the bucket lifting and opening/closing device 17 includes the lifting cylinder 18 provided on the arm 10, the first lifting sheave 19 and the first opening/closing sheave 21 moving in a length direction (the front-rear direction) of the arm 10 with the lifting cylinder 18, the second lifting sheave 23 separated from the first lifting sheave 19 and provided on the arm 10, the second opening/closing sheave 30 separated from the first opening/closing sheave 21 and provided on the arm 10, the opening/closing cylinder 31 moving the second opening/closing sheave 30 relative to the first opening/closing sheave 21, the lifting rope 38 whose one end is mounted on the arm 10, whose other end is mounted on the clamshell bucket 9, and whose intermediate portion is looped around the first lifting sheave 19 and the second lifting sheave 23, and the opening/closing rope 40 whose one end is mounted on the arm 10, whose other end is mounted on the clamshell bucket 9, and whose intermediate portion is looped around the first opening/closing sheave 21 and the second opening/closing sheave 30. Then, the arm 10 has a first opposing surface (the left side surface plate 11A of the arm body 11 and the left side plate 14A of the sheave mounting member 14) and a second opposing surface (the right side surface plate 11B of the arm body 11 and the right side plate 14B of the sheave mounting member 14) that are opposite in a direction perpendicular to the length direction of the arm 10 (the right-and-left direction), and the first lifting sheave 19 is disposed on the outer side surface of the left side plate 14A of the sheave mounting member 14 and the second lifting sheave 23 is disposed on the outer side surface of the left side surface plate 11A of the arm body 11, the first opening/closing sheave 21 is disposed on the outer side surface of the right side plate 14B of the sheave mounting member 14, and the second opening/closing sheave 30 and the opening/closing cylinder 31 are disposed on the outer side surface of the right side surface plate 11B of the arm body 11.

According to this configuration, the first lifting sheave 19 and the second lifting sheave 23, and the first opening/closing sheave 21 and the second opening/closing sheave 30 can be disposed in the direction perpendicular to the length direction of the arm 10 by interposing the arm 10. As a result, the first lifting sheave 19, the second lifting sheave 23, the first opening/closing sheave 21, and the second opening/closing sheave 30 can be disposed on an outer side surface of the arm 10. Consequently, the lifting rope 38 and the opening/closing rope 40 can regularly be replaced, and the bucket lifting and opening/closing device 17 can be maintained to maintain and inspect the first lifting sheave 19, the second lifting sheave 23, the first opening/closing sheave 21, the second opening/closing sheave 30 and the like in a large working space outside the arm 10 to enhance the operational efficiency.

In the embodiment, the arm 10 is provided with the slack adjusting cylinder 48 adjusting slack of the opening/closing rope 40 and the slack adjusting sheave 47 mounted on the slack adjusting cylinder 48 and around which the intermediate portion of the opening/closing rope 40 is looped, and the slack adjusting sheave 47, the second opening/closing sheave 30, and the first opening/closing sheave 21 are consecutively disposed from a front side of the arm 10 (the front end 11E side of the arm body 11). Thus, the slack adjusting sheave 47, the second opening/closing sheave 30, and the first opening/closing sheave 21 can be consecutively disposed from the front side of the arm 10 to shorten the looping distance of the opening/closing rope 40 between the sheaves and shorten the length of the opening/closing rope 40. Consequently, the operational efficiency for looping the opening/closing rope 40 around the slack adjusting sheave 47, the second opening/closing sheave 30, and the first opening/closing sheave 21 can be enhanced, and the weight of the bucket lifting and opening/closing device 17 can be reduced.

In the embodiment, the arm 10 is configured to include the arm body 11 composed of a hollow cylinder and the pair of guide arms 12, 13 detachably provided on the rear side of the arm body 11 and opposite each other by interposing the lifting cylinder 18 and extending in the front-rear direction. Then, the sheave mounting member 14 moving in the front-rear direction with the lifting cylinder 18 is mounted on the pair of guide arms 12, 13, and the first lifting sheave 19 and the first opening/closing sheave 21 are disposed on the sheave mounting member 14 so as to be opposite by interposing the lifting cylinder 18. According to this configuration, the entire length of the arm 10 can be set according to varied lengths of the guide arms 12, 13 mounted on the arm body 11. For example, in a case where the entire length of the arm 10 is increased by prolonging the guide arms 12, 13, the excavation depth of a pit by the deep foundation excavator 1 can be increased. Meanwhile, in a case where the guide arms 12, 13 are contracted to reduce the entire length of the arm 10, the arm 10 can be made to be lighter to enhance the transportability.

In the embodiment, the lifting cylinder 18 is accommodated within the arm body 11. According to this configuration, the bucket lifting and opening/closing device 17 can be made in smaller scale than in a case where the lifting cylinder 18 is configured to be disposed outside the arm 10. Also, the lifting cylinder 18 can be protected by the arm body 11.

In the embodiment, the lifting guide sheave 33 guiding the other end 38B of the lifting rope 38 to the clamshell bucket 9 and the opening/closing guide sheave 34 guiding the other end 40B of the opening/closing rope 40 to the clamshell bucket 9 are provided on the left side surface plate 11A of the arm body 11, and the left side surface plate 11A of the arm body 11 is disposed on the operator's seat 4A side provided on the upper revolving structure 3. According to this configuration, as shown in FIG. 1, for example, the clamshell bucket 9 can be raised and lowered in the vertical direction from the front end of the arm 10 (front end 11E of arm body 11) side, with the arm 10 held horizontal to the ground, to excavate a pit. Consequently, a pit can smoothly be excavated, using the deep foundation excavator 1, even at an indoor working site having working height restrictions, for example. Moreover, an operator seated in the operator's seat 4A can constantly visually confirm the state of the lifting rope 38 and the opening/closing rope 40 extending from the lifting guide sheave 33 and the opening/closing rope 40 to the clamshell bucket 9. Consequently, the operability for operating the bucket lifting and opening/closing device 17 can be enhanced.

In the embodiment, the opening/closing guide sheave 34 guiding the other end 40B of the opening/closing rope 40 to the clamshell bucket 9 is provided on the left side surface plate 11A of the arm body 11, the slack adjusting sheave 47 is provided on the right side surface plate 11B of the arm body 11, and the intermediate guide sheave 37 guiding the opening/closing rope 40 looped around the slack adjusting sheave 47 to the opening/closing guide sheave 34 is provided on the arm 10. According to this configuration, the opening/closing rope 40 can smoothly be guided from the slack adjusting sheave 47 to the opening/closing guide sheave 34 via the intermediate guide sheave 37 even in a case where the slack adjusting sheave 47 and the opening/closing guide sheave 34 are disposed to be opposite each other by interposing the arm body 11.

In the embodiment, the arm body 11 has the left side Surface plate 11A and the right side surface plate 11B that are opposite in the direction perpendicular to the length direction of the arm 10, and the upper surface plate 11C connecting upper ends of the left side surface plate 11A and the right side surface plate 11B, and a stepped surface 11G is formed on the front side of the arm 10 defined on the upper surface plate 11C, the stepped surface being lower than on a rear side of the arm 10 defined on the upper surface plate 11C, and the intermediate guide sheave 37 is disposed on the stepped surface 11G. This configuration can restrict projection of the intermediate guide sheave 37 from the upper surface plate 11C of the arm body 11, and the height of the deep foundation excavator 1 above the ground can be reduced as much as possible in a case where the deep foundation excavator 1 excavates a pit, with the arm 10 held horizontal to the ground.

In the embodiment, the case where the arm 10 is separably configured by the arm body 11, the pair of guide arms 12, 13 and the sheave mounting member 14 is illustrated. However, the present invention is not limited to that, and it may constitute an arm composed of a single angular tubular body including a first opposing surface and a second opposing surface having a rectangular-shaped cross section that are opposite in a direction perpendicular to a length direction, and a first lifting sheave and a second lifting sheave may be provided on the first opposing surface of the arm, and a first opening/closing sheave and a second opening/closing sheave may be provided on the second opposing surface.

In the embodiment, the case where the arm body 11 and the sheave mounting member 14 are each configured by an angular tubular body having a rectangular-shaped cross section is illustrated. However, the present invention is not limited to that, and an arm body and a sheave mounting member may be formed, using a cylinder having a cross section of a polygonal shape other than a rectangle or of a circle, for example.

Further, In the embodiment, the bucket lifting and opening/closing device 17 including the slack adjusting sheave 47 and the slack adjusting cylinder 48 adjusting slack of the opening/closing rope 40 is illustrated. However, the present invention is not limited to that, and the slack adjusting sheave 47 and the slack adjusting cylinder 48 may be removed from the bucket lifting and opening/closing device 17 provided on the arm 10.

### DESCRIPTION OF REFERENCE NUMERALS

1: Deep foundation excavator
2: Lower traveling structure (Vehicle body)
3: Upper revolving structure (Vehicle body)
4A: Operator's seat
5: Working mechanism
6: Boom
9: Clamshell bucket
10: Arm
11: Arm body
11A: Left side surface plate (First opposing surface)
11B: Right side surface plate (Second opposing surface)
11C: Upper surface plate (upper surface)
11E: Front end
11G: Stepped surface
12, 13: Guide arm
14: Sheave mounting member
14A: Left side plate (first opposing surface)
14B: Right side plate (second opposing surface)
17: Bucket lifting and opening/closing device
18: Lifting cylinder
19: First lifting sheave
21: First opening/closing sheave
23: Second lifting sheave
30: Second opening/closing sheave
31: Opening/closing cylinder
33: Lifting guide sheave
37: Intermediate guide sheave
38: Lifting rope
38A, 40A: One end
38B, 40B: The other end
40: Opening/closing rope
47: Slack adjusting sheave
48: Slack adjusting cylinder

1. A deep foundation excavator comprising a self-propelled vehicle body and a working mechanism provided on the vehicle body, wherein
the working mechanism comprises:
a boom provided on the vehicle body;
an arm provided on a tip end of the boom;
a bucket lifting and opening/closing device provided on the arm;
and a clamshell bucket liftably provided on the arm and excavating a pit by a lifting operation and an opening/closing operation with the bucket lifting and opening/closing device, wherein
the bucket lifting and opening/closing device comprises:
a lifting cylinder provided on the arm;
a first lifting sheave and a first opening/closing sheave moving in a length direction of the arm with the lifting cylinder;
a second lifting sheave separated from the first lifting sheave and provided on the arm;
a second opening/closing sheave separated from the first opening/closing sheave and provided on the arm;
an opening/closing cylinder moving the second opening/closing sheave relative to the first opening/closing sheave;
a lifting rope whose one end is mounted on the arm and whose other end is mounted on the clamshell bucket, and whose intermediate portion is looped around the first lifting sheave and the second lifting sheave; and
an opening/closing rope whose one end is mounted on the arm and whose other end is mounted on the clamshell bucket, and whose intermediate portion is looped around the first opening/closing sheave and the second opening/closing sheave, wherein
the arm has a first opposing surface and a second opposing surface that are opposite in a direction perpendicular to the length direction of the arm, wherein
the first lifting sheave and the second lifting sheave are disposed on an outer side surface of the first opposing surface, and
the first opening/closing sheave, the second opening/closing sheave and the opening/closing cylinder are disposed on an outer side surface of the second opposing surface.

2. The deep foundation excavator according to claim 1, wherein
the arm is provided with a slack adjusting cylinder adjusting slack of opening/closing rope and a slack adjusting sheave mounted on the slack adjusting cylinder and around which the intermediate portion of the opening/closing rope is looped, wherein
the slack adjusting sheave, the second opening/closing sheave and the first opening/closing sheave are disposed from a front side of the arm in sequence.

3. The deep foundation excavator according to claim 1, wherein
the arm is configured to include an arm body composed of a hollow cylinder and a pair of guide arms detachably provided on a rear side of the arm body, opposite each other by interposing the lifting cylinder and extending in the front-rear direction.

4. The deep foundation excavator according to claim 3, wherein
a sheave mounting member moving in the front-rear direction with the lifting cylinder is mounted on the pair of guide arms, wherein
the first lifting sheave and the first opening/closing sheave are disposed on the sheave mounting member to be opposite each other by interposing the lifting cylinder.

5. The deep foundation excavator according to claim 3, wherein
the lifting cylinder is accommodated within the arm body.

6. The deep foundation excavator according to claim 1, wherein
a lifting guide sheave guiding the other end of the lifting rope to the clamshell bucket and an opening/closing guide sheave guiding the other end of the opening/closing rope to the clamshell bucket are provided on the first opposing surface, and
the first opposing surface is disposed on an operator's seat side provided on the vehicle body.

7. The deep foundation excavator according to claim 2, wherein
an opening/closing guide sheave guiding the other end of the opening/closing rope to the clamshell bucket is provided on the first opposing surface,
the slack adjusting sheave is provided on the second opposing surface, and
the arm is provided with an intermediate guide sheave guiding the opening/closing rope looped around the slack adjusting sheave to the opening/closing guide sheave.

8. The deep foundation excavator according to claim 7, wherein
the arm has the first opposing surface and the second opposing surface that are opposite in the direction perpendicular to the length direction of the arm and an upper surface connecting upper ends of the first opposing surface and the second opposing surface, wherein
a stepped surface is formed on the front side of the arm defined on the upper surface, the stepped surface being lower than on a rear side of the arm defined on the upper surface, wherein
the intermediate guide sheave is disposed on the stepped surface.
